(19) United States
(12) Patent Application Publication
(10) Pub. No.: US 2018/0255820 A1
(43) Pub. Date: Sep. 13, 2018

(54) DIETARY SUPPLEMENTS, FOOD INGREDIENTS AND FOODS COMPRISING HIGH-PROTEIN ALGAL BIOMASS

(71) Applicant: Zivo Bioscience, Inc., Keego Harbor, MI (US)

(72) Inventor: Andrew A. Dahl, Bloomfield Hills, MI (US)

(21) Appl. No.: 15/913,712

(22) Filed: Mar. 6, 2018

Related U.S. Application Data
(60) Provisional application No. 62/467,984, filed on Mar. 7, 2017.

(51) Int. Cl. A23L 33/135; A23P 10/35; A23P 10/40; A23L 27/10; A23L 7/13; A21D 2/36; A21D 13/064

(52) U.S. Cl. CPC A23L 33/135; A23P 10/35; A23P 10/40; A23V 2002/00; A23L 7/13; A21D 2/36; A21D 13/064; A23L 27/10

(57) ABSTRACT

An algal-derived consumable comprises: (i) an algal biomass derived from at least one species of algae, such as Klebsormidium; and (ii) optionally at least one additional ingredient, such as flavoring ingredients, colorants, seasonings, food additives, food components, and nutrients. The consumable may comprise a dietary supplement, a food ingredient or a finished food product. A method of manufacturing a consumable comprises: harvesting raw wet algae, removing water to produce a de-watered algal material; optionally cutting and/or shaping the de-watered material; drying; and optionally seasoning.

### CROSS-REFERENCE TO RELATED APPLICATIONS

This application claims priority to, and the benefit of, U.S. Provisional Patent Application Ser. No. 62/467,984 filed Mar. 7, 2017 and entitled “Algal-Derived Protein Supplement,” the disclosure of which is incorporated herein by reference in its entirety.

### FIELD OF THE INVENTION

The present invention relates to human nutrition and in particular to dietary supplements, food ingredients and foods comprising a high-protein algal biomass and related processing methods to obtain same.

### BACKGROUND OF THE INVENTION

It is well established that insufficient nutrition lowers a person's immunity to infections and chronic diseases and contributes to mortality rates. Current research supports the notion that good nutrition can prevent many disease states, and can reduce the recovery time during medical treatment of various diseases, injury or other stress and immune related injuries and illnesses. It is now known, for example, that calcium and vitamin D are important for bone strength and to prevent bone loss, folic acid decreases the risk of certain birth defects, and omega-3 fatty acids (e.g. fish oils) may reduce the incidence of heart disease. Further, protein consumption is essential in human nutrition, where it supplies the essential amino acids and contributes to cell repair and healthy metabolism.

Many of the world's populations fail to consume the daily recommended dietary levels of protein for various reasons. In underdeveloped countries, one reason for the lack of nutrition is poverty. In developed countries, vegetarians and vegans may not be consuming enough protein, and the availability of convenient, high carbohydrate processed foods also results in low protein intake even amongst non-vegetarians in highly developed countries.

Consequences of a low-protein diet and poor eating habits in general, include acquired gluten sensitivity, insufficient immune system, muscle loss, pain, slow recovery from injury and illness, obesity, poor mental acuity, and fatigue, amongst others.

In view of the extent of third world poverty, the popularity of vegetarian diets globally, and the continuing propensity for persons in developed countries to simply eat poorly even when financially well off, new dietary supplements and food ingredients that can augment the nutritional profile of foods are always needed for the promotion of general health.

### SUMMARY OF THE INVENTION

In various aspects of the present disclosure, algal-derived dietary supplements, food ingredients and resulting food compositions for human consumption are disclosed. These consumable supplements and foods comprise an algal biomass derived from at least one species of algae, and optionally at least one additional ingredient to impart taste or other attributes to the consumables. In various examples, the algal biomass comprises at least one Klebsormidium species of algae, and in certain examples, is obtained by processing the biological material of NCMA Deposit # PATENT201602001, such as by draining and/or compressing the biomaterial to remove associated liquid components.

Dietary supplements, food ingredients and foods (herein, collectively referred to as “consumables”) may comprise dried algae in the form of flakes, granules or powder, and optionally at least one additional ingredient such as seasoning. The consumable may be provided in the form of a dry “shake-on” seasoning product, which when added to foods, provides both seasoning and protein enrichment to the food. In various aspects, food having inadequate levels of dietary protein, or no protein content at all, can be enhanced by an algal-derived consumable in accordance to the present disclosure. In other aspects, a consumable comprising dried algae may be physically embodied in the form of sheets, wraps, shells, bowls, strands, chips, puffs, crisps, or crackers. These physical forms may be obtained from a dried biomass comprising at least one Klebsormidium species of algae. In various examples, such an algal biomass is obtained by processing the biological material of NCMA Deposit # PATENT201602001.

An algal-derived consumable in accordance to the present disclosure may include at least one additional ingredient, such as a seasoning, including for example, salt, sugar, red pepper, black pepper, parsley, oregano, cilantro, toasted seeds of various varieties, monosodium glutamate, onion powder, garlic powder, or citric acid. The consumable may further include at least one other ingredient that imparts some other attribute to the consumable besides flavor, such as, for example, an antioxidant, preservative, colorant, anti-caking agent, flow agent, Vitamins and minerals. In some examples, algae cells are coated and/or agglomerated so that the algal flakes or particles for the consumable retain much of their firmness in hot foods and in a person's mouth, to enable an extended mouth feel. In certain aspects, a consumable may be fortified with a variety of vitamins and minerals, such as, for example, Vitamin A, Vitamin B₁, Vitamin B₂, Vitamin B₆, Vitamin B₁₂, Vitamin C, Vitamin D, Vitamin E, calcium, magnesium, zinc, selenium, iodine and iron.

In accordance to the present disclosure, methods of producing various consumables, such as dietary supplements and foods, are disclosed. In various aspects, a method includes drying an algal biomass and mixing the dried algal material with at least one additional ingredient to form the dietary supplement, food ingredient or food. In other examples, an algal biomass is first mixed with at least one other ingredient and then dried. Drying an algal biomass may be in concert with a molding process, such as to produce dried algae in a particular shape, such as a bowl, taco shell, or stackable chip shape. An algal biomass may be dried, for example, by air drying, by heated drying, or by freeze drying.

Methods of producing an algal-derived consumable may also include steps to coat, emulsify or encapsulate the algae, macroscopically and/or microscopically at the cellular level, such that the chlorophyll in the algal cells does not leach out and color the dietary supplement, food ingredient or foods therefrom a green color. In various aspects, a fatty acid, a plant oil or other lipid is used to coat or emulsify the intact algal cells when wet, or used to coat and/or emulsify bulk dried algal biomass in the form of flakes, sheets, granules or powder. In other embodiments, algal cells are encapsulated with a polymer prior to drying, or dried algal biomass is coated with a polymer subsequent to drying.

Also disclosed herein are methods of increasing a nutritional factor of a food by adding to the food in need of a nutritional enhancement an algal-derived food ingredient. In certain examples, the nutritional factor is protein. In increasing a nutritional factor of a food, an algal-derived food ingredient may also add to the flavor of the food by providing at least one seasoning in addition to providing protein.

### BRIEF DESCRIPTION OF THE DRAWING FIGURES

FIG. 1 illustrates an embodiment of a drum drying operation suitable for use in producing algae sheets 200 in accordance to the present disclosure.

### DETAILED DESCRIPTION OF THE INVENTION

An algal-derived consumable comprises an algal biomass derived from at least one species of algae, such as a species of Klebsormidium. An algae-derived consumable in accordance to the present disclosure may be in the form of a dietary supplement or food product for direct human consumption, or in the form of a food ingredient that can be added to foods, such as a seasoning blend or food additive.

Biological Deposit

An algal biomass for use herein may be obtained by processing the biological material of NCMA Deposit # PATENT201602001. A deposit of biological material that may be used to obtain an algal biomass comprising at least one species of Klebsormidium in accordance to the present disclosure was deposited on Oct. 6, 2006 at the Provasoli-Guillard National Center for Marine Algae and Microbiota—Bigelow Laboratory for Ocean Sciences, (NCMA, Maine, U.S.A.), and assigned by the International Depositary Authority accession # PATENT201602001. This deposit is available to the public upon grant of a patent disclosing the same. This deposit was made pursuant to 37 C.F.R. § 1.808 and MPEP § 2410.01 and, therefore, access to the deposit will be available during pendency of this application making reference to the deposit to one determined by the Commissioner to be entitled thereto under 37 C.F.R. § 1.14 and 35 U.S.C. § 122 and with one exception, that all restrictions imposed by the depositor on the availability of the deposited biological material to the public be irrevocably removed upon the granting of the patent.

### Definitions

As used herein, the term “consumable” is meant to broadly encompass all physical forms of edible food products intended for human consumption, whether in the form of a dietary supplement (e.g., tablet, capsule, etc.), a snack food (e.g., chips, crisps, puffs, crackers, etc.), an entre (e.g. nori-type sushi sheets, dried pasta strands, vegetable medley, etc.), or a food ingredient (e.g. a seasoning blend, a protein additive for food manufacturers, etc.) used with, on, or in other foods such as to augment a particular nutritional factor in the food and/or to season or otherwise change a food's appearance, aroma, texture, and/or flavor. In non-limiting examples, which are discussed below, a consumable food ingredient may be in the form of flakes, granules, powder, or seasoning blends, comprising for example only dried algae by itself or dried algae plus at least one additional ingredient. In other examples, a consumable food product comprising at least one species of algal may be in the form of sheets, wraps, chips, puffs, crisps, strands, noodles, macaroni, cereals, edible bowls or shells, or other molded, extruded or formed shapes, and the like.

As used herein, the term “algal-derived consumable” refers to a consumable in accordance to the above definition that comprises algal material from at least one species of algae. In certain examples, the algal material comprises a Klebsormidium algal biomass, which provides relatively high protein content. An algal biomass herein may be obtained by processing the biological material of NCMA Deposit # PATENT201602001. An algal-derived consumable herein may also be referred to more simply as a “protein enhancer,” emphasizing one exemplary use of an algal-derived food ingredient, such as a shake-on seasoning, to enhance the protein level in foods that may have low to no protein. Such a protein enhancer, even consisting essentially of dried algae, may be used by third party food producers as a protein enriching food ingredient for their manufactured products, spanning everything from body-building shakes to microwavable dinners.

The term “algal biomass” is used herein to generally refer to cellular material (e.g. whole algal cells) derived from naturally occurring or genetically modified algae (“GMO algae”). For example, in various embodiments, an algal biomass comprises freeze-dried or otherwise desiccated algae of one or more species of algae. In various embodiments, an algal biomass may comprise flaked, granulated, powdered desiccated algae from one or more species. An exemplary algal biomass may be derived from a Klebsormidium species of algae by freeze-drying the cellular material and optionally flaking, powdering, milling or granulating the cellular material obtained upon drying, or by molding the wet algae into a shape and then drying. In certain aspects, an algal biomass is obtained by processing a Klebsormidium species of algae, such as, for example, by draining and/or compressing it a mechanical press to remove the liquid components and then drum-drying or freeze-drying the remaining cellular material. The algal biomass comprising at least one species of Klebsormidium may be obtained by processing the biological material of NCMA Deposit # PATENT201602001 in accordance to the bioprocessing methods disclosed herein. An algal biomass may be formulated into an algal-derived consumable for human consumption by drying the algal biomass comprised of at least one species of algae and optionally mixing the dried material with at least one additional ingredient to produce an algal-derived consumable. These aspects of formulating an algal biomass into various consumables are discussed in more detail below.

As used herein, the term “dietary supplement” is meant to broadly encompass all physical forms of a nutritional product intended for humans. Thus, a “dietary supplement” herein is the “dosage form” or the “unit dose” of a nutritional composition, such as to provide a particular recommended amount of a nutrient. For example, a dietary supplement in accordance to the present disclosure may be designed for oral or sublingual usage, and thus may be in the form of a pill, tablet, caplet, soft capsule, powder filled capsule, chewable wafer or nodule, or thin film/dissolving strip. Supplements designed for nasal administration to a human, for example, may be in the form of a liquid, such as a liquid packaged as a nasal spray. In a non-limiting example, a dietary supplement herein comprises dried algal biomass compressed into a caplet. The caplets may be consumed by a person in need of additional daily protein or other nutrients. Dried and powdered Klebsormidium species of algae is particularly useful herein for the production of powder-filled capsules and compressed tablets and caplets for human consumption of an algal-derived dietary supplement.

Algal Biomass for Use in an Algal-Derived Consumable

An algal biomass for use herein may comprise any species of algae. Various factors may influence the choice of a particular species of algae for use in an algal-derived consumable. These factors include such considerations as (i) the availability of the species, such as its prevalence in nature or its amenability for cost-effective culturing; (ii) the nutrient content of the algae; and (iii) its ability to be processed. For example, a particular algae species may be farmed directly from natural ponds or oceans, or may be grown in large quantities in artificially controlled tanks of freshwater or saltwater. Also, particular algae species may be chosen because they provide relatively high levels of protein and correspondingly low levels of lipid. Further, certain species of algae may be more amenable to processing, such as drying into sheets, flakes, granules or powders. In certain instances, it may be desirable to find species of algae that can be manipulated in a paste form, such as having the ability to be pressed into molds and subsequently dried into three-dimensional shapes, such as bowls, shells or stackable chips.

Certain species of algae are known to contain high levels of protein, and thus are useful as algal material for an algal-derived consumable in accordance to the present disclosure. Some of these species, with their associated protein on a dry basis, include Dunaliella tertiolecta (20 wt. %) and Nannochloris atomus (30 wt. %), both from the Chlorophyceae class of green algae. Other green algae providing high levels of protein include Chlorella (e.g., Chlorella pyrenoidosa and Chlorella vulgaris, about 58 wt. % protein), Bracteacoccus grandis (about 55-30 wt. %), Neochloris oleoabundans (from about 55-20 wt. % protein), and Phaeodactylum tricornutum (from about 50-40 wt. % protein). Also, dried Spirulina, a genus of blue-green algae, (e.g., including the species of Anthrospira platensis and Arthrospira maxima), has about 51-71 wt. % protein content. Not only are protein levels variable between algae species, protein levels within a particular species can change over the growth stages of the species, (e.g. early log, late log, stationary, and late stationary growth stages). Thus, harvesting of algae for use in an algal-derived consumable herein may be appropriately timed such that algae with the highest protein levels are harvested.

An algal biomass for use herein may be derived from the genus Klebsormidium, as the various species of Klebsormidium provide an acceptable balance of cost-effective culturing (e.g. in open ponds or in tanks), fairly high protein levels on a dried basis, and versatility and ease in processing into edible materials. Klebsormidium is a genus of filamentous charophyte green algae of 20 known species, including K. acidophilum, K. bilatum, K. crenulatum, K. dissectum, K. drouetii, K. elegans, K. flaccidum, K. fluitans, K. fragile, K. klebsii, K. lamellosum, K. montanum, K. mucosum, K. nitens, K. pseudostichococcus, K. scopulinum, K. sterile, K. subtile, K. subtilissimum, and K. tribonematoideum. In various embodiments, an algal biomass for use herein is derived from any presently known, or yet to be discovered, species of Klebsormidium algae.

For example, an algal biomass for use herein may be derived from an algae species selected from the group consisting of K. acidophilum, K. bilatum, K. crenulatum, K. dissectum, K. drouetii, K. elegans, K. flaccidum, K. fluitans, K. fragile, K. klebsii, K. lamellosum, K. montanum, K. mucosum, K. nitens, K. pseudostichococcus, K. scopulinum, K. sterile, K. subtile, K. subtilissimum, K. tribonematoideum, and mixtures thereof.

Furthermore, an algal biomass for use herein may be derived from algae species selected from the group consisting of Klebsormidium nitens, Klebsormidium flaccidum, and mixtures thereof. In various embodiments, an algal biomass for use herein may be derived from Klebsormidium nitens. Also, an algal biomass for use herein may be derived from Klebsormidium flaccidum.

Algal biomass comprising at least one species of Klebsormidium may be obtained by processing the biological material of NCMA Deposit # PATENT201602001. As disclosed herein, the culturing of the biological material of NCMA Deposit # PATENT201602001 produces algal colonies comprising at least one species of Klebsormidium algae that may be grown to sufficient quantities for harvesting. In various examples, the algal biomass obtained by processing the biological material of NCMA Deposit # PATENT201602001 comprises algae species selected from the group consisting of Klebsormidium nitens, Klebsormidium flaccidum, and mixtures thereof.

Some algae species, even those providing relatively high levels of protein, are known to also contain high levels of lipids. These species able to provide lipids are perhaps more attractive for biodiesel production rather than for human food. The various species of Klebsormidium, on the other hand, are found to contain relatively high levels of protein and relatively low levels of lipids. Further, the various species of Klebsormidium also provide a variety of other nutrients important for human health besides just protein. Thus, in various embodiments of the present disclosure, an algal-derived consumable comprises a dried Klebsormidium biomass having the nutritional profile set forth below.

Algal Biomass from Cultured Algae

In various aspects of the invention, an algal biomass for use herein comprises whole algal cells of one or more algal cultures grown in distilled water supplemented with various sterilized materials. A method of producing an algal biomass suitable for use in the various consumables herein comprises culturing a sample of the biological material of NCMA Deposit # PATENT201602001 and separating the solid and liquid components to obtain the algal biomass. In some instances, an algal biomass is used in its raw form, i.e., as a wet mass of cellular material, or in a further processed form, such as after some removal of liquid, or more extensive drying by freeze drying, ambient drying or heated drying. In utilizing algae for consumables, it may be practical to use algae in any of these stages of wetness, from raw/wet to essentially free of water.

A freeze-dried sample of algae comprising Klebsormidium was determined to contain a variety of nutrients important for human health. Furthermore, the freeze-dried algal biomass was virtually completely odorless and tasteless, and was free of heavy metals, harmful microbes, and toxins. TABLE 1 sets forth the complete nutritional analysis of one exemplary Klebsormidium algal biomass. In TABLE 1, “wt. %” refers to the percentage of the analyte on a weight/weight basis. The Klebsormidium algal biomass analyzed herein was obtained by processing the biological material of NCMA Deposit # PATENT201602001, straining the crude algae, and drying the drained material to obtain the dried biomass having less than 5 wt. % water, as described herein below under EXAMPLES.

TABLE 1
Nutritional analysis of a Klebsormidium algal biomass

| Analyte | Value | Method Used |
|---|---|---|
| Cis-cis-Polyunsaturated Fat (wt. %) | 5.41 | AOAC 996.06 |
| Monounsaturated Fat (wt. %) | 0.13 | AOAC 996.06 |
| Saturated Fat (wt. %) | 2.15 | AOAC 996.06 |
| Total Fat (wt. %) | 8.04 | AOAC 996.06 |
| Trans Fat (wt. %) | 0.01 | AOAC 996.06 |
| Fructose (wt. %) | <0.25 | CM4200 |
| Glucose (wt. %) | 0.49 | CM4200 |
| Lactose (wt. %) | <0.25 | CM4200 |
| Maltose (wt. %) | <0.25 | CM4200 |
| Sucrose (wt. %) | <0.25 | CM4200 |
| Total Sugars (wt. %) | 0.49 | CM4200 |
| Ash (wt. %) | 3.80 | CM4001 |
| Calcium (mg/100 g) | 79.4 | CM5004 |
| Calories (Cal/100 g) | 411 | Calculation |
| Carbohydrates (wt. %) | 42.02 | Calculation |
| Cholesterol (mg/100 g) | <1 | (subcontracted) |
| Iron (mg/100 g) | 7.36 | CM5004 |
| Moisture (wt. %) | 3.54 | CM4012 |
| Protein (wt. %) | 42.6 | CM4006 |
| Sodium (mg/100 g) | 172.2 | CM5004 |
| Total Dietary Fiber (wt. %) | 23.9 | AOAC 991.43 |
| Vitamin A (beta carotene) (IU/100 g) | 24,425 | MN4101 |
| Vitamin C (mg/100 g) | 117.98 | CM4104 |

As shown in TABLE 1, Klebsormidium algal biomass comprises Vitamin A primarily in the form of beta-carotene. Further, the 42.02 wt. % “Carbohydrates” found in the Klebsormidium algal biomass includes about 8 to 9 wt. % of non-starch polysaccharides known to have various medicinal and health benefits.

TABLE 2 lists key nutritional components (from TABLE 1) found present in one exemplary freeze-dried sample of algal biomass comprising Klebsormidium (nutrient amounts in TABLE 2 refer to the amount of the nutrient present in 100 grams freeze-dried algal biomass).

TABLE 2
Key nutrients in freeze-dried Klebsormidium biomass

| | AMOUNT PER 100 G |
|---|---|
| NUTRIENT | ALGAL BIOMASS |
| Vitamin A | 24,425 IU |
| Vitamin C | 118 mg |
| Calcium | 79 mg |
| Protein | 43 grams |

TABLE 3 sets forth a comparative nutritional profile illustrating how an exemplary Klebsormidium algal biomass in accordance to the present disclosure compares to other foods.

TABLE 3
Comparative nutritional profiles

| | | | | | | | | | | | yogurt | | Muscle | | Soy | |
|---|---|---|---|---|---|---|---|---|---|---|---|---|---|---|---|---|
| | Algal | | | | | | | | | | (1 cup, | | Milk | | beverage | |
| | Biomass | | Spirulina | | beef liver | | spinach | | orange | | plain, | | protein | | w/protein | |
| | (100 g, | | algae (100 g, | | (3 oz., | | (1 cup, | | (medium- | | whole | | powder | | powder | |
| | dried) | | dried) | | raw) | | raw) | | sized) | | milk) | | (100 g) | | (100 g) | |
| Vitamin A | 24,425 | IU | 570 | IU | 14,363 | IU | 2813 | IU | 295 | IU | 243 | IU | 2500 | IU | 0 | IU |
| Vitamin C | 118 | mg | 10 | mg | 1 | mg | 8 | mg | 70 | mg | 1 | mg | 30 | mg | 0 | mg |
| Calcium | 79 | mg | 120 | mg | 4 | mg | 30 | mg | 52 | mg | 296 | mg | 500 | mg | 178 | mg |
| Protein | 43 | g | 57 | g | 17 | g | 0 | g | 1 | g | 9 | g | 46 | g | 56 | g |
| Iron | 7 | mg | 29 | mg | 4 | mg | 0 | mg | 0 | mg | 0 | mg | 9 | mg | 12 | mg |
| Fiber | 24 | g | 4 | g | 0 | g | 0 | g | 3 | g | 0 | g | 7 | g | 7 | g |
| Sodium | 172 | mg | 1048 | mg | 59 | mg | 24 | mg | 0 | mg | 113 | mg | 329 | mg | 733 | mg |
| Cholesterol | 0 | mg | 0 | mg | 234 | mg | 0 | mg | 0 | mg | 32 | mg | 21 | mg | 0 | mg |

TABLE 4 sets forth a comparison of the protein content and amino acid content in an exemplary Klebsormidium algal biomass in comparison to other food sources of protein. The presence of an asterisk (*) adjacent to an amino acid in the table indicates the amino acid is an essential amino acid.

TABLE 4
Comparative protein content

| | | BlueWave | Advance | Source | | | |
|---|---|---|---|---|---|---|---|
| | Freeze | Fish Protein | Fish Protein | Organic | Soy flour, | Whey, acid, | Spirulina, |
| Per 100 grams of | dried algal | Isolate | Powder | Whey | defatted | dried | dried |
| product | biomass | (CONC) | (CONC) | (CONC) | (CONC) | (Natural) | (Natural) |
| Protein in grams | 42.6 | 85 | 87 | 85 | 51.46 | 11.73 | 57.47 |
| Aspartic acid (g) | 2.22 | 1.68 | 1.33 | 2.50 | 2.87 | 2.45 | 2.52 |
| Alanine (g) | 1.88 | 1.32 | 0.85 | 0.94 | 1.08 | 1.09 | 1.97 |
| Arginine (g) | 1.67 | 1.35 | 0.87 | 0.31 | 1.77 | 0.70 | 1.81 |
| Cystine (g) | 0.23 | 0.00 | 0.24 | 0.08 | 0.37 | 0.45 | 0.29 |
| Glutamic acid (g) | 2.43 | 2.48 | 1.93 | 5.32 | 4.43 | 4.48 | 3.65 |
| Glycine (g) | 1.40 | 2.38 | 0.74 | 0.39 | 1.05 | 0.45 | 1.35 |
| Histidine (g)* | 0.38 | 0.25 | 0.36 | 0.23 | 0.62 | 0.49 | 0.47 |
| Isoleucine (g)* | 0.94 | 0.63 | 0.59 | 1.17 | 1.11 | 1.24 | 1.40 |
| Leucine (g)* | 1.98 | 1.19 | 1.02 | 2.42 | 1.86 | 2.39 | 2.15 |
| Lysine (g)* | 1.21 | 1.10 | 1.14 | 1.95 | 1.52 | 2.15 | 1.31 |
| Methionine (g)* | 0.32 | 0.53 | 0.73 | 0.50 | 0.31 | 0.47 | 0.50 |
| Phenylalanine* | 1.34 | 0.66 | 0.54 | 0.47 | 1.19 | 0.83 | 1.21 |
| Proline (g) | 1.20 | 1.20 | 0.55 | 1.48 | 1.34 | 1.49 | 1.04 |
| Serine (g) | 1.02 | 1.15 | 0.48 | 1.09 | 1.32 | 1.15 | 1.31 |
| Threonine (g)* | 1.17 | 0.85 | 0.63 | 1.71 | 0.99 | 1.26 | 1.29 |
| Tryptophan (g)* | 0.51 | 0.00 | 0.31 | 0.23 | 0.33 | 0.51 | 0.40 |
| Tyrosine (g) | 0.90 | 0.54 | 0.45 | 0.47 | 0.86 | 0.64 | 1.12 |
| Valine (g)* | 1.25 | 0.82 | 0.67 | 1.03 | 1.14 | 1.24 | 1.53 |

From these results and comparisons, it can be seen that an algal biomass comprising Klebsormidium provides a unique blend of protein and micronutrients, and as such, is an ideal non-animal source of protein nutrition with very little fat. In various embodiments herein, an algal biomass derived from at least one species of klebsormidium is processed into a consumable having various physical forms to take advantage of these nutritional profiles.

Methods of Processing, Drying and Shaping Algae for Use in an Algal-Derived Consumable

There are several methods to dry or even to “cook” algae to obtain algal material suitable for use in an algal-derived consumable product in accordance to the present disclosure. In general, thermal efficiency of air circulation dryers for algae can be low, largely when the raw algae, such as seaweed or kelp, are in relatively large pieces that restrict the flow of moisture to the surface of the algae where evaporation occurs. Large pieces of algae also provide less surface area exposed to the hot air. For certain species of algae, prior reduction of the pieces of algae to particles for drying can result in a mucilaginous mass, which tends to mat together and prevent the flow of the hot air through the bed of algae particles. However, in many cases, fresh algae, including Klebsormidium as cultured herein, is either physically small or it can be milled and the resultant pulp can be economically dried. In general, the more “woody” the algae species is, the more readily it can be blended in a blender prior to drying.

In various embodiments, methods used for drying and flaking, granulating or powdering, or deep frying fresh algae solids, such as Klebsormidium, include, but are not limited to, freeze drying, spray drying, drum drying, pulse drying, pulse combustion drying, oven drying, microwave drying, drying and rolling flat in a commercial nori machine, or deep frying. These methods have their various advantages and disadvantages. For example, freeze drying, although efficient, requires a secondary process such as milling or chopping to reach a final powdered or flaked dry algal product. Spray drying can rupture intact cells because of the high-pressure atomization process, although if the cellular contents remain with the ruptured cells as the algal material is incorporated into a consumable, this may not be a concern.

Drum drying is an efficient process to produce dry algae, and can be used to produce algae sheets. The drum dryer is a so-called thin-film contact dryer. A very thin layer of the algae to be dried is applied to the outside of a rotating cylinder (drum), optionally along with other substances. This drum is heated on the inside by steam. When in contact with the heated surface, the liquid evaporates very quickly from the thinly spread algae layer. Steam heating provides uniform temperature distribution over the drum surface resulting in a consistent product. Two drums may be disposed in close proximity and rotated in opposite directions, squeezing the material between the drums as the material is being dried. One type of drum dryer is an ANDRITZ Gouda drum dryer, (available from ANDRITZ AG, Stattegger Strasse 18, 8045 Graz, Austria). Klebsormidium is particularly suitable for drying in a drum dryer. In various aspects, Klebsormidium algal biomass, such as obtained by culturing the biological material of NCMA Deposit # PATENT201602001, may be drum dried directly into nori-(seaweed) style sushi sheets for direct human consumption or for crushing into flakes or powder for use as a food ingredient.

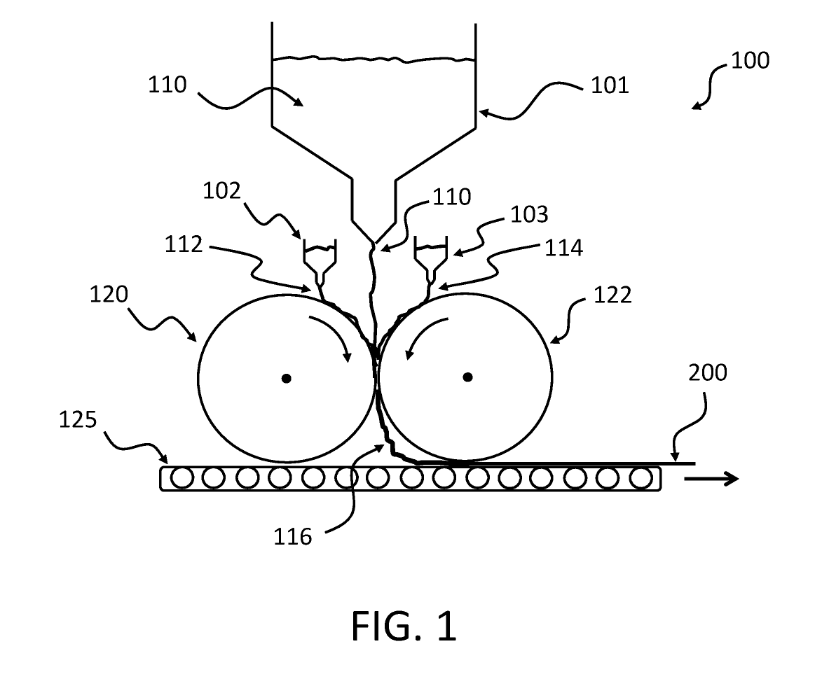

An embodiment of a drum drying operation suitable for use in producing algae sheets 200 in accordance to the present disclosure is illustrated in FIG. 1. In this embodiment, two rotating drum rollers 120 are disposed in close proximity to one another, such as separated by a gap equivalent to the desired thickness of a dried algae sheet. The leading drum 122 may also be positioned close to the moving conveyor 125 to form a gap approximately equal to the desired thickness of the algae sheet. A vessel 101 is positioned above the gap between the rotating drums, and is used to meter out algae biomass 110 into the gap between drums. Optionally, additional metering vessels such as 102 and 103 may be used to add other materials to the rotating drums that will combine with the algae biomass as the streams converge between drums. For example, two additional metering vessels 102 and 103 may provide alginate or another polymer or other material to coat the algae. As shown, metering vessels 102 and 103 are positioned and adjusted to supply streams of material 112 and 114 to the drums, respectively. The drums 120 and 122 operate to compress the materials 110, 112 and 114 together and to at least partially dry the resulting composition 116 into the final algae sheet 200. In various embodiments, the resulting algae sheet 200 comprises a dried algae material with alginate or other material coated on both sides of an algae center layer. If only one metering vessel 102 or 103 is utilized, then the resulting algae sheet 200 will have only one side coated with this additional material. In some cases, the emerging algae sheet 200 may pass through another drying operation, such as through an oven, prior to being crushed into flakes or ground into a powder. The algae biomass material 110 may comprise wet algae culture that has been blended to a certain thickness, or it may be a processed form of an algae biomass, such as a culture that has been separated into liquid and cellular components and then suspended again and blended to achieve a certain thickness or other characteristic. In certain examples, other food ingredients, such as seasonings, may be added directly into any of the metering vessels 101, 102 and 103. For example, salt or other seasonings may be mixed directly into the wet algae biomass 110 in vessel 101. In further variations of the process 100 of FIG. 1, the additional metering vessels 102 and 103 may be eliminated and the materials that would have been added to the rotating drums is coated onto the finished algae sheet 200 in a separate process, such as by spraying or roll coating.

Another efficient method of producing dried algal flakes is to use a commercial nori machine used to produce nori seaweed sheets, e.g., one equipped with microwave drying. The dried sheets of algae thus obtained can then be gently crushed into flakes or more robustly ground into a powder and then that material used as a food ingredient in a seasoning blend or in a finished food product such as a stackable chip, puff or crisp.

Processing of algae such as Klebsormidium begins by harvesting during the particular growth period when a nutritional factor, such as protein, is at its peak. Water is removed, such as by mechanical pressing or centrifugation, to yield a “yogurt-like” de-watered substance that can be dried by any of the methods above to produce bright green flakes or powder for a consumable in accordance to the present disclosure. Raw Klebsormidium algal biomass can be “stringy.” Even though the individual algal cells are rod-like and only measure about 750 nanometers in length, they tend to attach end-to-end creating relatively long strands of about 2 to 3 millimeters in length. Thus, Klebsormidium processing can require shearing for proper drying by conventional means. However, it has been discovered that if the algal biomass is left stringy when spray drying, the effluent from the spray dry nozzle can be directed at a flat surface, whereby a “felt-like” material is produced whose thickness can be manipulated. For this process, a modified industry-standard commercial food-grade spray dryer is used. This process can be applied to any filamentous algae occurring naturally in these strands, or that can be sheared to a similar length.

In various embodiments, the resulting felt-like material can be dried to a about a 10% moisture content, leaving it with the texture of coarse felt but flexible enough to be used directly as a vegan sandwich wrap material, burrito wrap, or other such food application without further drying. The material can be cut into circles, square or rectangles and vacuum-bagged to prevent spoilage. Adding xanthan gum and other natural preservatives such as salt and vinegar will also extend shelf-life. In other examples, the consumable is a refrigerated food product. It certain aspects, small flat squares may be packaged in similar fashion to individual serving cheese slices, using plastic film, to keep material from sticking together. This material may also be extruded through very small diameter dies to create threads that resemble pasta noodles. The extruded threads may then be dried further and packaged and sold as a substitute for traditional semolina wheat pasta.

If the felt-like material is dried to approximately 5% or less moisture content, it can then be shaped into flat or cupped nacho, taco, stackable chip or other crisp snack shapes, with optional seasoning added. Thus, in various embodiments, a method of making an algal-derived consumable in the form of nachos, tacos, stackable chips or other crisp snack shapes comprises spray drying raw stringy Klebsormidium through a spray dryer nozzle against a flat surface to produce a felt-like material, drying the felt-like material to about 5% moisture or less, shaping the material on or in a three-dimensional mold into the cupped nacho, taco, stackable chip or other crisp snack shape, and then drying in an air circulation dryer or conventional oven, or frying in a suitable oil, to produce the final food product. In general, the process of spray-drying algal biomass can lead to product forms such as shell or chip shapes. For example, spray dried Klebsormidium may be dried further to about 5% moisture or less, cut and then shaped into individual pieces on “saddle-shaped” molds, and dried until crisp to produce stackable snack chips resembling Kellogg's Pringles® snack chips. Stackable means that each snack chip has the same three-dimensional curvature such that a plurality of chips can be stacked neatly in a cylindrical container, i.e., a tube. In various aspects, wet, partially wet, or dry Klebsormidium may by blended with any combination of vegetable oil, rice flour, wheat flour, corn flour, wheat starch, wheat bran, barley flour, modified food starch, emulsifiers, seasonings, and the like prior to shaping on the saddle-shaped molds to produce stackable chips resembling the size, density and texture of Kellogg's Pringles® snack chips. Such stackable chips may be packaged in closable cylindrical (tube) containers for retail sale.

The step of shaping algal biomass into a consumable product may include the use of deeper molds. For example, raw wet algae or de-watered algal material may be pressed into molds of various shapes, such as resembling muffin or cupcake tins, and then the filled molds placed in the air dryer or oven for a time sufficient to dry the algae into the molded food product shapes. Molds may comprise any shape, such as hemispherical bowls, or cups to produce three-dimensional edible shapes, such as bowls. These formed shapes have the advantage of being “fillable” with other foods, wherein the shaped and dried algae biomass is the “edible bowl.” In various aspects, algal biomass is dried into the shape of a taco bowl used for taco salads or to hold soups.

Microwaving, deep-frying or conventional oven drying of extruded algal biomass creates light, crispy and very green snack foods, such as resembling puffed snacks. Raw wet algal may be mixed with other food ingredients and then extruded in a heated extruder through a die to make a snack food resembling the shape and consistency of Cheetos® cheese puffs. The heated extrusion chamber creates steam from the moisture in the extruding slurry to puff-up (expand with air pockets) the extrudate. For example, algal biomass may be mixed with cornmeal, water, oil and flavorings, and then extruded under pressure through a heated extruder to make the raw snack as an extruding “snake.” The snack curls cut from the die at desired lengths may then be baked or fried to obtain the final consumable puffed food snack.

At the raw wet stage or at a de-watered stage, the algae may be deep fried rather than air dried. For example, rolled thin sheets of algal biomass, measuring for example less than about ⅛ inch in thickness, may be cut with dies into small shapes of edible size and deep fried at from about 350° F. to about 500° F. for time sufficient for each piece to cook and become crisp.

Raw, wet algal biomass may be mixed with various flavors, colorants, seasonings or spices and then dried by heated drum rollers, by belt drying or spray drying to create a flaked (for “shake-on” product) or powdered (for “stir-in” product) consumable “protein enhancer.” In other embodiments, dried algal biomass, (e.g. dried by any method above) is mixed with various seasonings and then agglomerated or aggregated by commonly used food processing methods to form a flake, granulated or powdered product. In various aspects, dried and flaked or powdered algal is used by third party food producers as a protein-enhancing food ingredient for whatever foods are produced.

Methods of Coating, Emulsifying, or Encapsulating Algae with a Lipid and/or a Polymer to Mitigate the Coloring of Foods

An algal-derived consumable food ingredient or spice blend comprising a species of green algae, such as for example, a species of Klebsormidium, can color foods a green color when added to foods. This coloring may be undesirable depending on the type and temperature of the food the algae-derived ingredient is added to. The green color of green algae is from chlorophyll present in the algal cells, and thus methods to keep algal cells intact throughout the processing of the algae into consumable and/or methods of coating dried algae can help mitigate this undesired coloring of other foods by the algae-derived consumable product. In general, mitigation of undesired coloring is accomplished by at least one of coating, emulsification, and encapsulation, with at least one lipid and/or at least one polymer. In various aspects, the at least one lipid or polymer may be provided as a solution, emulsion or suspension in a solvent such as water or an alcohol.

Algae may be coated, emulsified and/or encapsulated at any stage in the conversion of an algal culture into an algal-derived consumable product. For example, raw wet algae may be mixed with a lipid or polymer. Or, an algal culture may be drained of some or most of the water to produce partially dried/damp algae prior to addition of a lipid or polymer. Alternatively, completely dried algae, in any physical form such as powder, granules, sheets or flakes, may be coated or emulsified with a lipid or a polymer, such as by spraying directly on the algae or mulling the dried algae with a lipid or polymer. In general, raw wet algae, partially dried algae, or completely dried algae may be coated, emulsified, or encapsulated with a lipid or a polymer, or solutions, emulsions or suspensions therefrom.

Emulsification or encapsulation of algal cells prior to drying improves stability of intact cells throughout the processing steps from raw algae to finished algal-derived consumable. However, coating of dried algae with at least one lipid or polymer accomplishes a similar mitigation of color leaching. Thus, any combination of coating, emulsifying or encapsulating substance (e.g. a lipid or polymer) and any degree of wetness for the algae, is within the scope of the present disclosure. For example, raw wet algae may be treated with any combination of lipid or polymer. In other examples, partially dried but damp algae may be treated with any combination of lipid or polymer. Also, completely dried algae in any physical form such as powder, granule, sheet, flake, etc., may be treated with any combination of lipid or polymer.

“Treatment” for purposes herein includes any method for combining a coating, emulsifier or encapsulating agent with algae. Such methods include, but are not limited to, pouring, mixing, blending, mulling, spraying, spray drying, coating, and the like. The precise method for combining a lipid or polymer with algae depends, in part, on the degree of dryness of the algae (e.g. if the algae is still raw and wet, partially separated from excess water, or completely dried), and the physical form of the wet, partially wet, or dried algae. For example, an algae culture may be mechanically blended into a slurry while adding, or prior to addition of, a lipid or polymer to the blender apparatus. In another non-limiting example, a dry algal powder may be placed in a ribbon blender and a spray bar used to spray a lipid or polymer or solution, emulsion or suspension thereof on the algae as it tumbles within the ribbon blender.

For purposes herein, the terms “coating,” emulsifying,” and “encapsulating” may be used interchangeably. Interchanging these terms underscores the fact there is no limitation placed on the mechanism by which color leaching may be mitigated. For example, a fatty acid, a surfactant, an oil, or a polymer may coat individual algal cells or may emulsify and stabilize clusters of cells or bulk algal material (biomass). In other instances, a lipid or polymer may infiltrate cell membranes and coat intracellular constituents, such as the chloroplasts wherein the chlorophyll resides. Or, individual algal cells may be coated by a polymer or surrounded within a surfactant micelle to render the cell membrane impassible to chlorophyll. In other aspects, a lipid or polymer may macroscopically coat an algal biomass to form a physical shell that can temporarily shield the algae from leaching color into a food.

In various aspects, the coating, emulsification, or encapsulation may also affect the rate at which an algal-derived consumable softens under particular conditions. The rate at which an algal-derived consumable softens is also associated with the “mouth feel” of the algal material in a person's mouth. For example, coating, emulsification or encapsulation at any step in the processing of algae may result in an algal-derived consumable that physically stands up to hot foods, such as soups, pasta and stews, at a temperature of from about 100° to about 212° F., for a period of time from about 1 min to about 12 hours. In other examples, algae processed in a manner that includes coating, emulsification or encapsulation results in an algal-derived consumable that remains firm in the mouth, (e.g. in 98.6° F. saliva environment), for as long as about 1 second to about 5 minutes, during which time the person continues to feel the texture of the consumable in the mouth. In various embodiments, the nature of the coating, emulsifying or encapsulating substance, the amount of the substance, the processing method, and/or the temperature at which the consumable is exposed to, affect the amount of time until an algal-derived consumable begins to leach color into a food, and the amount of time an algal-derived consumable can retain a particular mouth feel in a person's mouth.

In various examples, raw wet algae are first mixed with at least one lipid for the purpose of emulsifying or coating individual cells or groups of cells. A lipid for this purpose may comprise a single fatty acid, a blend of fatty acids, or derivatives therefrom. Blends of fatty acids may be synthetically formulated by combining individual fatty acids. In other examples, a blend of fatty acids may be naturally occurring, such as the fatty acid blend of a particular vegetable or animal fat. In non-limiting examples, fatty acids may be from about C₈ to about C₂₂ in chain length, with any degree of unsaturation at any position along the carbon chain, and with any combination of cis- and trans-olefin orientation. Derivatives of fatty acids may include, for example, salts of fatty acids, i.e. soaps, or mono-, di-, or triglycerides of fatty acids. Natural fatty acid blends may include, for example, corn oil, sunflower oil, safflower oil, canola oil, olive oil, lard, tallow, or any other vegetable oil or animal fat. These natural fats may include fatty acid mono-, di- and/or triglycerides in any combination. Fatty acids for use herein may also be fully hydrogenated or partially hydrogenated to adjust the degree of unsaturation. Mono- and di-glycerides of fatty acids may also be reacted on the one or two free hydroxyl groups of the glycerin molecule, such as through ethoxylation or esterification of the one or two available hydroxyl substituents.

Other lipids include surfactants that are not fatty acids per se. Surfactants for use herein may include any surfactant usable in food compositions, such as for example, polyoxyethylene sorbitan fatty acid esters, known as “polysorbate,” (e.g., polysorbate 20, 60, 65, or 80). Other useful surfactants may be any anionic, nonionic, cationic, or amphoteric surfactant for food use. Other usable materials that are lipids, or that act as lipids, include, but are not limited to, lecithin, honey, mustard, calcium stearoyl-2-lactylate, polyglycerol esters, acetylated glycerides, and glyceryl esters.

A lipid or mixture of lipids may be added to raw wet algae at a level of from about 0.0001 wt. % to about 50 wt. % active lipid material, based on the total weight of the wet algae material. A lipid or mixture of lipids may be added to a wet algal culture and then the culture stirred such as from gently to vigorously, for a time sufficient to mix the lipid(s) with the algae. In other embodiments, partially dried (e.g. drained) algal material may be sprayed with at least one lipid or a solution, emulsion or suspension of at least one lipid. The algal cells present in raw wet algae may be microencapsulated with a polymer, such as, for example, agarose, alginate, carrageenan, chitosan, gellan gum hyaluronic acid, collagen, elastin, gelatin, fibrin, or the like. Polymers for use herein may be entirely naturally occurring, synthetically modified natural polymers, or entirely synthetic polymers, such as made by polymerization reactions. At least one polymer may be added to raw wet algae at a level of from about 0.0001 wt. % to about 50 wt. % active polymer, based on the total weight of the wet algae material.

Once algal cells are coated, emulsified or encapsulated, the raw algae may then be further processed as described, such as dried. In this way the dried algal biomass comprises emulsified or encapsulated intact cells, and will be less prone to coloring foods. Further, coating, emulsification or encapsulation of algal cells prior to the processing of the algal biomass tends to stabilize the physical structure of the biomass regardless if the biomass has been further processed into agglomerated granules or into flakes. The presence of the emulsifier or polymer around the algae imparts a structural stability to the algal-derived consumable that can be felt as a stable and lingering mouth feel in the mouth, or that can be visually seen as a physical stability to the affects of hot foods such as soups and stews.

In other embodiments, a lipid and/or polymer is added to dried algae or added to the process during which algae is dried. Three particular embodiments comprise:

(1) Belt drying, wherein algae is rapidly heated and rapidly cooled to produce dried algal flakes of any desired size, which are then subsequently coated with at least one lipid and/or at least one polymer. The size of the flake may vary from about the size of a dried spice flake (e.g. about 1 mm) to about the size of a cereal flake (e.g. about 1 cm). The addition of a lipid or a polymer to dried algae flakes may be accomplished by spraying. Any size flake may be coated. Spraying onto algae may be accomplished while the algae flakes are coming off the belt but not yet collected, or may be subsequent to collection. Lipids and polymers may be diluted, emulsified or suspended in any amount of solvent (e.g. water or an alcohol) as needed to improve spraying on the algae flakes.

(2) Spray drying of algae slurry into an extremely fine powder which is then processed into granules that resemble dried black pepper or other very small flake. For this process, the lipid and/or polymer may already be present in the algal slurry prior to spray drying, or may be sprayed into the falling algae particles descending in the spray drying tower.

(3) Drum drying of algae within two opposing drums, wherein the algae is dried into sheets and subsequently cut into ribbons. For this process, the algae may be premixed with at least one lipid or polymer prior to the drum drying operation or may be sprayed onto the sheets or ribbons after the drum drying operation. FIG. 1 illustrates an embodiment of drum drying between two opposing drums.

In another variation, the dried algae material (such as a powder, granulate or flaked product), optionally including at least one additional ingredient such as a seasoning ingredient, may be mulled with an oil, such as olive oil, to produce a paste. This paste, comprising up to about 80 wt. % oil, shows stability in hot foods such as soups, pasta, and stews, wherein the green color of the algae is confined to the paste up to the time the food is consumed. In certain aspects, the oil encapsulates the fine algae particles, and the water-based food is unable to quickly mix with the oil-based consumable product. In various aspects, such a paste may be used as a substitute for pesto.

The at Least One Additional Ingredient for an Algal-Derived Consumable Product

An algal-derived consumable in accordance with the present disclosure comprises an algal biomass derived from at least one species of algae, and optionally at least one additional ingredient, such as a seasoning ingredient, a food additive ingredient, such as to impart a property such as color, anti-caking or storage stability, a food component (a flour, a starch, a meal, oils, water, etc., such as to form a paste or dough useful for producing a final food product), or a nutritional ingredient to further enrich the product. As mentioned, an algal biomass derived from at least one species of algae may be dried and then mixed with at least one additional ingredient to produce an algal-derived consumable. In various example, these steps may be reversed such that at least one additional ingredient is added to an algal biomass prior to drying. Also, at least one additional ingredient may be added to an algal biomass at any stage of processes, such as at a raw wet stage, a de-watered stage, or at a fully dried stage.

In non-limiting examples, an algal-derived consumable comprises at least one seasoning ingredient. Seasoning ingredients may be mineral or organic. Mineral based ingredients include, but are not limited to, salt (sodium chloride), potassium chloride (sodium free “salt”), calcium hydroxide and alum. Organic seasoning ingredients are more prevalent in the food industry, and include, for example, black pepper, white pepper, various chili peppers, paprika, smoke, sugar, citric acid, tartaric acid, malic acid, garlic powder, onion powder, coriander, cumin, tarragon, basil, oregano, parsley, mint, various herbs as leaves or as seeds, sesame seeds, sunflower seeds, ground toasted tree nuts, and the like. Any of these, and any other food seasonings imaginable, may be used singly or in any combination in an algal-derived consumable herein. Smoke flavor may be added to the algae during the drying process, such as by adding burning embers to the dryer or adding artificial smoke flavoring to raw wet or de-watered algae. Other seasonings may be mixed in before drying, or sprinkled on after drying of the algae. Many seasoning ingredients are commercially available, and are already processed for use (such as dried and ground). For example, basil may be commercially obtained as small dried flakes or dried powder. Sesame seeds, for example, may be black or white, raw or toasted. Salt, for example, may be granular or coarse, iodized or not, mined from the ground or obtained from the sea.

Food additive ingredients for use in an algal-derived consumable impart at least one property to the consumable other than seasoning. For example, a food additive ingredient may be chosen from antioxidants, microbial preservatives, color stabilizers, flow agents, anti-caking agents, leavening agents, and coloring agents, and the like. Thus, a property added to the consumable may be oxidative stability, uv light stability, microbial stability, storage stability in general, color, anti-caking, flow, ability to leaven, etc. In non-limiting examples, tricalcium phosphate or silica is added to a dry powdered algal biomass to ensure the resulting algal-derived consumable remains free-flowing from its container. Monosodium glutamate (MSG) may be added for flavor enhancement. In other examples, an FD & C color is added to the raw wet or de-watered algal material to impart a color to the finished algal-derived consumable. Also, yeast or baking soda or powder may be added to an algal biomass as part of a batter or dough intended to “rise” prior to, or during a cooking process.

Seasoning and the various non-seasoning ingredients disclosed may be added to the algal material at a level sufficient to impart a desired result. For example, salt may be added to a dried algal biomass to produce an algal-derived consumable having a pleasant savory taste, or at the level sufficient to impart a savory seasoning to the food that the consumable is added to. Various seasoning ingredients introduced may be very mild relative to the amount of algal biomass so as not to over-season soups, salads, vegetable dishes, and the like and to encourage adding a generous (e.g. 1 wt. oz. or more) amount of algal flakes or pesto-like powder to any dish, hot or cold. In certain aspects, an algal-derived consumable in accordance to the present disclosure is in the form of a “shake-on” or “stir-in” seasoning product for foods. In these instances, seasoning ingredients may be added at a relatively high level, such that when used in large volumes of food, the seasonings are not over diluted and lost.

The food component is an edible material that may help transform the algal biomass material into a blended paste or dough usable to produce a final finished food product. In various aspects, a food component may be selected from the group consisting of water, vegetable oil, shortening, animal oil, animal fat, dried fish powder, dried powdered cheeses, potato flakes, rice flour, wheat flour, corn flour, corn starch, cornmeal, wheat starch, potato starch, wheat bran, barley flour, modified food starch, and mixtures thereof. This listing of food components is not meant to be inclusive, as any food recipe presently known or conceived of in the future may suggest other food components outside this listing. These particular food components, used singly or in various combinations, find use in producing finished foods such as snack chips, nacho chips, puffed snacks, crackers, breads, cereals, pasta noodles, taco shells, taco salad bowls, pastry shells, tortillas, and other foods that involve a batter or dough and a cooking process.

In certain aspects, the optional at least one additional ingredient may comprise a nutritional ingredient. In instances where a particular algae species is deficient in a particular nutrient, such as Vitamin B₁₂, that nutrient may be included in the algal-derived consumable. In non-limiting examples, a nutrient may be selected from various vitamins and minerals, such as, for example, Vitamin A, Vitamin B₁, Vitamin B₂, Vitamin B₆, Vitamin B₁₂, Vitamin C, Vitamin D, Vitamin E, calcium, magnesium, zinc, selenium, iodine and iron.

Methods of Using an Algal-Derived Consumable Directly as a Food Product or to Enhance Other Foods

An algal-derived consumable in accordance to various aspects of the present disclosure may be added to food, for example, blended into foods by manufacturers or shaken on or stirred into foods by the consumer at home, or eaten directly as a food. By adding an algal-derived consumable such as a seasoning blend or protein-enhancing food ingredient to foods, at least one nutritive factor is improved. A nutritive factor herein includes, but is not limited to, proteins, vitamins and minerals. Thus for example, an algal-derived consumable may be added to a food to increase the amount of protein in the food. In other non-limiting examples, an algal-derived consumable added to a food may increase the level of a vitamin or a mineral in the food.

A method of increasing the protein level of a food comprises adding an algal-derived consumable to the food. In various aspects, the algae-derived consumable consists essentially of Klebsormidium algae, wet or dried to various stages of dryness, which is used by third party food producers to augment the protein or other nutritive values in their manufactured food products. In more specific examples, the Klebsormidium algae is dried to less than about 5 wt. % moisture, ground or flaked, and then provided to food producers to add to foods during their manufacture. Each of these foods, regardless of type (canned soup, boxed pasta noodles, cellophane wrapped veggie burgers, etc.) can be marked on the product packaging with some sort of indicia (a name, a logo, etc.) that identifies the presence of the Klebsormidium algae in the manufactured food product.

The possible physical forms for an algal-derived consumable in accordance to the present disclosure are virtually limitless. More typically, an algal-derived consumable herein may comprise flakes, granules, powder, paste, chips, crisps, puffs, crackers, sheets, strands, noodles, and various three-dimensional shapes, such that the product can be eaten as a snack food, wrapped around foods, used to hold foods, or added to other foods as a food ingredient to enhance a food. In various embodiments, an algal-derived consumable is a “shake-on” or a “stir-in” protein enhancer and seasoning product. In various aspects, the novel concept is a shake-on or stir-in protein enhancer and seasoning to boost the protein content of a wide range of low-protein foods and to augment the protein intake in vegetarian or vegan diets with an animal-free, dairy-free, gluten-free, extremely low-fat, plant-based source of protein combined with flavoring agents, seasonings and spices.

In various examples, an algal-derived consumable comprises a pesto flavored shake-on protein/seasoning for pasta, salads and soups that mimics the flakes/granules of ground basil leaves, pine nuts and garlic. A paste version may comprise de-watered but not fully dried algal material mixed with spices such as basil, pine nuts and garlic. A paste version may be packaged in metal or plastic “toothpaste-type” tubes in similar fashion to tomato paste and anchovy paste. Other iterations range from umami to barbeque flavorings, ethnic spice combinations and sweet variations that mimic fruits and natural sugars. In various aspects, the seasoning component may comprise a very small portion of the shake-on or stir-in product, which consists mostly of algal biomass or algal protein. In other embodiments, seasonings may be at higher levels to ensure the shake-on or stir-in product imparts enough of the seasoning to the food it's added to.

Consumers may be instructed to shake-on or stir-in at least 1 wt. ounce of an algal-derived consumable into foods. In various embodiments, a 1 wt. ounce (28.35 grams) portion of an algal-derived consumable adds from about 10 grams to about 20 grams protein to the food serving it is added to. In certain examples, a 1 wt. ounce (28.35 grams) portion adds about 15 grams of protein to the food serving. The amount of protein that an algal-derived consumable can provide is dependent on a number of factors, including for example, the species of algae used, the processing methods, and the nature of the finished product wherein the at least one additional ingredient factors into the overall nutritional statement of the product. For example, inert materials such as anti-caking agents suffice to dilute the overall nutritional content of the product by adding non-nutritive weight.

In various embodiments, a 1 wt. ounce (28.35 grams) of a shake-on or stir-in algal-derived consumable provides from about 110 to about 130 calories. In certain examples, a 1 wt. ounce (28.35 grams) serving provides about 120 calories.

An algal-derived consumable may be mixed in with salad dressing, oils, fats, or acids to create flavorful, protein-rich dressings, sauces and marinades, and also mixed into dry-mix soups, sauces, marinades to boost protein and flavor.

### EXAMPLES

### Example I: Preparation of an Algal Biomass for Use in the Manufacture of a Consumable

1. Preparation of an Algal Biomass (Single Culture to Small Culture):

A sample of NCMA Deposit # PATENT201602001 was used to grow algae axenically on an mBBM (modified Bold's Basal Medium) agar petri plate. A single colony was picked from the plate and grown in mBBM media in a shake flask for one month to achieve adequate density for roux bottle inoculation. Algae inoculum grown in roux bottles was progressively divided to produce the minimum inoculation density required for panel reactor growth. Algae biomass grown in reactors was placed in a 25 μm filter sock to remove supernatant using gravity flow. Excess supernatant was removed with manual squeezing of the filter sock until the consistency of the algal biomass reached a thick paste. The algal biomass was then spread into a ½ inch layer on a stainless steel tray and placed at −80° C. until frozen. The tray was then moved to a vacuum equipped freeze-drier, and the material held at −50° C. to −60° C. for several days until the moisture level was reduced to about 5 to 10% by weight. The freeze-dried algal biomass was stored in a refrigerator at 4° C. or in a freezer at −20° C. until use.

2. Preparation of an Algal Biomass (Scale-Up of Small Culture):

Monocultures of a filamentous alga (from Example 1 above) are grown in 120 L and 240 L flat panels with a 4-inch light path, 3-9 mM NO₃ in mBBM media, and CO₂/air mixing or within outdoor, covered, HEPA filtered ponds using natural light. Harvesting consisted of drawing off the liquid and algae that is contained in the liquid and separating the liquid from the algal biomass. There is typically about 1.4 grams of algae per liter of water. Upon harvesting, biomass is placed in a 25 μm filter sock to remove water using gravity flow. Excess water is removed with manual squeezing resulting in a wet paste that is about 15% solids and 85% water. The appearance of the biomass is that of a bright green thick paste. On average, about 8-10 kg wet weight yields about 1 kg of algal biomass in the form of a paste. This material is then spread onto stainless steel trays in a ½″ layer and placed in a −80° C. freezer until frozen or ready for further processing. Freeze dried biomass is achieved by placing the tray in a freeze-drier equipped with a vacuum pump and set at −50° C. to −60° C. for several days until the moisture level was reduced to 5-10%. Freeze-dried biomass was stored in a refrigerator at 4° C. or freezer at −20° C. until use. The 5-10% moisture biomass may be used in the methods disclosed herein, such as spray drying, or can be dried further to have essentially no water, wherein the algal biomass appears as a dark green powder or brittle cake. In this manner, Klebsormidium algal biomass in multi-kilogram quantities is ultimately obtained from NCMA Deposit # PATENT201602001. However, it should be recognized that other sources of Klebsormidium algae cells can be used to inoculate reactors for growing substantial quantities of Klebsormidium algae.

### Example II: Consumable Products

1. General Aspects:

In various embodiments, an algal-derived consumable comprises: (i) an algal biomass as obtained in Example I, part 2 above; and (ii) optionally at least one additional ingredient. At least one species of algae produced in Example I, part 2 comprises a Klebsormidium species of algae. An algal biomass herein comprises algae species selected from the group consisting of Klebsormidium nitens, Klebsormidium flaccidum, and mixtures thereof. An algal biomass may comprise Klebsormidium nitens. Also, an algal biomass may comprise Klebsormidium flaccidum.

An algal-derived consumable comprises: (i) an algal biomass as obtained in Example I, Part 2 above; and (ii) at least one additional ingredient that imparts at least one property to the algal-derived consumable. The at least one property is selected from seasoning, flavor, color, anti-caking, flow, oxidative stability, uv light stability, storage stability, and nutritive profile. The at least one additional ingredient is selected from seasonings (inorganic or organic), flavorings, smoke, colorants, other food ingredients (e.g. seeds, tree nuts), anti-caking agents, flow agents, preservatives, antioxidants, uv stabilizers, vitamins and minerals.

An algal-derived consumable comprises: (i) an algal biomass as obtained in Example I, Part 2 above; and (ii) at least one additional ingredient, wherein the algal-derived consumable is in the form of a powder, granulate, flake, agglomerate, paste, chip, slice, wrap, sheet, puffed snack, strands, noodles, or molded three-dimensional shape. The algal-derived consumable may be a “shake-on” or “stir-in” food seasoning product and may include secondary packaging for same.

A method of manufacturing an algal-derived consumable comprises: harvesting wet raw algae from Example I, Part 2; removing about 90% to about 95% of the water therein to produce a de-watered algal material; drying the de-watered material; and adding at least one additional ingredient to produce the algal-derived consumable. The step of drying may comprise at least one of freeze drying, spray drying, drum drying, pulse drying, pulse combustion drying, oven drying, microwave drying, drying and rolling in a commercial nori machine, or deep frying. In variations of the method, the step of adding at least one additional ingredient may be at any step in the method, including adding directly to algae prior to harvesting.

A method of manufacturing an algal-derived consumable comprises: harvesting raw wet algae from Example I, Part 2 as a raw stringy mass; spray drying the raw stringy algae through a spray dryer nozzle and against a flat surface to produce a felt-like material; drying the felt-like material to remove about 90%, 95%, or greater than about 95%, by weight of the water content; shaping the material into three-dimensional shapes or flat sheets or extruding through a die; drying the three-dimensional shapes, flat sheets or extruded shapes in an air circulation dryer or conventional oven, or by deep frying; and adding at least one additional product to produce the algal-derived consumable. The physical form of the algal-derived consumable may be nachos, tacos, stackable chips, puffs, bowls, cups, crisps, sheets, or other snack or food shapes. In variations of the method, the step of adding at least one additional ingredient may be at any step in the method, including adding directly to algae prior to harvesting.

A method of enhancing the protein content of a food comprises: providing an algal-derived consumable further comprising (i) an algal biomass from Example I, Part 2; and (ii) at least one additional ingredient; and adding the algal-derived consumable to the food in need of enhancement. The algal-derived consumable may contain from about 10-20 grams of protein by weight per 28.35 grams of algal-derived consumable, and may contain any additional profile of vitamins and minerals. In various embodiments, the algal-derived consumable comprises a “shake-on” or “stir-in” seasoning product that supplies seasoning to the food in need of enhancement, in addition to enhancing the protein content of the food.

2. Stackable Chips Comprising Klebsormidium Algae:

Algal biomass comprising Klebsormidium is obtained from the culturing of the biological material of NCMA Deposit # PATENT201602001 in accordance to Example I, Part 2 above. The raw algae is dried by any of the described methods to contain less than about 5 wt. % moisture content. The dried algae cake is blended with at least one additional ingredient selected from the group consisting of water, vegetable oil, animal oil, potato flakes, rice flour, wheat flour, corn flour, corn starch, wheat starch, potato starch, wheat bran, barley flour, modified food starch, emulsifiers, seasonings, and mixtures thereof, to create a pliable dough that is laid out in thin sheets measuring less than about ⅛ inch in thickness (i.e., the dough is sheeted). The sheets are then cut by dies into a plurality of oval-shaped pieces, each piece measuring about 1 to 2 inches×2 to 3 inches. The pieces are shaped on saddle-shaped molds to create a curvature in each oval piece, and then the pieces are deep fried in vegetable oil or shortening for less than about 1 minute at 350° to 500° F. to produce snack chips that are stackable in tube-shaped packaging due to each piece having a consistent saddle-shape. The final product resembles Kellogg's Pringles® snack chips except for the presence of a green color.

3. Puffed Snack Curls Comprising Klebsormidium Algae:

Algal biomass comprising Klebsormidium is obtained from the culturing of the biological material of NCMA Deposit # PATENT201602001 in accordance to Example I, Part 2 above. The raw algae is dried by any of the described methods to contain less than about 5 wt. % moisture content. The dried algae cake is blended with at least one additional ingredient selected from the group consisting of finely powdered, low-moisture cornmeal, water, vegetable oil, animal oil, potato flakes, rice flour, wheat flour, corn flour, corn starch, wheat starch, potato starch, wheat bran, barley flour, modified food starch, emulsifiers, seasonings, and mixtures thereof, to create an extrudable slurry having from about 6% to about 10% by weight moisture. The slurry is then extruded from an extruder having a heated extrusion chamber through a die of about ½ inch diameter, and the extrudate cut every several inches to produce a plurality of puffed curls. The curls are then oven dried at about 120° to about 200° F. for a time sufficient for the individual curls to become crisp and for the moisture content to lower to less than about 2 wt. %. The crisp puffed snack curls resulting therefrom are then optionally seasoned and packaged.

It will be apparent to those skilled in the art that various modifications and variations can be made to the present disclosure without departing from the spirit or scope of the disclosure. Thus, it is intended that the present disclosure cover the modifications and variations of this disclosure provided they come within the scope of the appended claims and their equivalents.

1. A consumable comprising a species of algae from the genus Klebsormidium, wherein the consumable is a dietary supplement, a food ingredient, or a food for human consumption.

2. The consumable of claim 1, wherein said species of algae comprises Klebsormidium acidophilum, Klebsormidium bilatum, Klebsormidium crenulatum, Klebsormidium dissectum, Klebsormidium drouetii, Klebsormidium elegans, Klebsormidium flaccidum, Klebsormidium fluitans, Klebsormidium fragile, Klebsormidium klebsii, Klebsormidium lamellosum, Klebsormidium montanum, Klebsormidium mucosum, Klebsormidium nitens, Klebsormidium pseudostichococcus, Klebsormidium scopulinum, Klebsormidium sterile, Klebsormidium subtile, Klebsormidium subtilissimum, or Klebsormidium tribonematoideum, or mixtures thereof.

3. The consumable of claim 2, wherein said species of algae comprises Klebsormidium nitens, or Klebsormidium flaccidum, or mixtures thereof.

4. The consumable of claim 1, wherein said species of algae is obtained by processing the biological material of NCMA Deposit # PATENT201602001.

5. The consumable of claim 1, wherein said species of algae is coated, emulsified or encapsulated with a lipid or a polymer.

6. The consumable of claim 1, wherein said dietary supplement comprises a tablet, caplet or powder-filled capsule, and wherein said species of algae comprises a dried and powdered Klebsormidium algal biomass having less than about 5 wt. % moisture content.

7. The consumable of claim 6, wherein said dried and powdered Klebsormidium algal biomass is obtained by processing the biological material of NCMA Deposit # PATENT201602001.

8. The consumable of claim 1, wherein said food ingredient consists essentially of dried and powdered Klebsormidium algal biomass having less than about 5 wt. % moisture content.

9. The consumable of claim 8, wherein said dried and powdered Klebsormidium algal biomass is obtained by processing the biological material of NCMA Deposit # PATENT201602001.

10. The consumable of claim 1, wherein said food comprises a shake-on or stir-in seasoning product further comprising at least one additional ingredient selected from the group consisting of flavoring ingredients, colorants, seasoning ingredients, food additive ingredients, food components, nutritional ingredients, and mixtures thereof.

11. The consumable of claim 1, wherein said food comprises a snack food in the physical form of stackable chips.

12. The consumable of claim 1, wherein said food comprises a snack food in the physical form of extruded puffs.

13. A method of producing a consumable comprising a species of algae from the genus Klebsormidium, the method comprising:
harvesting wet raw algae material from a culture of Klebsormidium algae, the material comprising both algal solids and water;
removing from about 90% to about 95% of the water to produce a de-watered algal material;
drying the de-watered material to produce a dried algal biomass having less than 5 wt. % moisture content; and
adding at least one additional ingredient to the dried algal biomass to produce the consumable.

14. The method of claim 13, wherein the at least one additional ingredient is selected from the group consisting of flavoring ingredients, colorants, seasoning ingredients, food additive ingredients, food components, nutritional ingredients, and mixtures thereof.

15. The method of claim 13, wherein the culture of Klebsormidium algae is obtained by processing the biological material of NCMA Deposit # PATENT201602001.

16. A method of producing a consumable comprising a species of algae from the genus Klebsormidium, the method comprising:
harvesting raw algae material from a culture of Klebsormidium algae, the material comprising both algal cellular material and water from the culture;
removing a portion of the water to create a paste comprising about 15% algal cellular material and about 85% water by weight;
spraying the paste through the nozzle of a spray dryer to generate a spray effluent, said spray effluent impinged upon a flat surface to produce a sheet of algal material; and
optionally drying the sheet of algal material to about 10 wt. % moisture content or less to produce the consumable product.

17. The method of claim 16, wherein the culture of Klebsormidium algae is obtained by processing the biological material of NCMA Deposit # PATENT201602001.

18. The method of claim 16, further comprising the steps of:
drying the sheet of algal material further to obtain a dried material having about 5 wt. % or less moisture content;
cutting the resulting dried material into pieces; and
drying the pieces in an air circulation dryer or conventional oven, or frying the pieces in oil to produce the consumable.

19. A method of producing a snack food chip comprising a species of algae from the genus Klebsormidium, the method comprising:
harvesting raw algae material from a culture of Klebsormidium algae, the material comprising both algal cellular material and water from the culture;
drying the raw algae material into a dried algal biomass having less than about 5 wt. % moisture content;
blending the dried algal biomass with at least one ingredient selected from the group consisting of water, vegetable oil, animal oil, potato flakes, rice flour, wheat flour, corn flour, corn starch, wheat starch, potato starch, wheat bran, barley flour, modified food starch, emulsifiers, seasonings, and mixtures thereof to produce a pliable dough;
sheeting the dough into a dough sheet;
cutting the dough sheet into shapes; and
cooking the shapes until crisp.

20. The method of claim 19, wherein the culture of Klebsormidium algae is obtained by processing the biological material of NCMA Deposit # PATENT201602001.
